(19) United States
(12) Patent Application Publication
(10) Pub. No.: US 2023/0228148 A1
(43) Pub. Date: Jul. 20, 2023

(54) Foldable Ladder

(71) Applicant: Tianjin Jinmao Houseware Products Co., Ltd, Tianjin (CN)

(72) Inventors: Jie Li, Tianjin (CN); Shengjiang Wang, Tianjin (CN); Fengming Li, Tianjin (CN)

(21) Appl. No.: 17/883,303

(22) Filed: Aug. 8, 2022

(30) Foreign Application Priority Data
Jan. 20, 2022 (CN) 202210064873.3

(51) Int. Cl. E06C 1/32; E06C 7/50

(52) U.S. Cl. CPC E06C 1/32; E06C 7/50; E06C 7/14

(57) ABSTRACT

Foldable ladder includes main ladder and auxiliary ladder, and top end of ladder frame of auxiliary ladder being connected to ladder frame of main ladder through hinge mechanism, wherein hinge mechanism includes main ladder hinge plate, auxiliary ladder hinge plate, and shaft pin lock assembly connecting main ladder hinge plate and auxiliary ladder hinge plate, wherein main ladder hinge plate includes first hinge plate, second hinge plate, and third hinge plate connected in “Z” shape sequentially, and in extending direction of pedal of main ladder: first hinge plate is fixed to outer side surface of ladder frame of main ladder, and located on outer side of third hinge plate; auxiliary ladder hinge plate is fixed to top end of ladder frame of auxiliary ladder, and shaft pin lock assembly passes through third hinge plate and auxiliary ladder hinge plate and connects auxiliary ladder hinge plate to third hinge plate.

### CROSS-REFERENCE TO RELATED APPLICATION

The present disclosure claims the priority to the Chinese patent application with the filing No. 2022100648733 filed on Jan. 20, 2022 with the Chinese Patent Office, and entitled “Foldable Ladder”, the contents of which are incorporated herein by reference in entirety.

### TECHNICAL FIELD

The present disclosure relates to the technical field of climbing tools, and in particular to a foldable ladder.

### BACKGROUND ART

In the prior art, the ladders are sometimes used as climbing tools for climbing. The existing ladders are mostly foldable ladders, and they are unfolded when being used and folded when being not used. Such ladders generally include two use angles, i.e., a “herringbone” angle when being unfolded and a storage angle close to “0 degree” when a main ladder and an auxiliary ladder are overlapped and closed; and the auxiliary ladder is required to be rotatable relative to the main ladder, and a rotation mode is generally realized by providing a rotation structure between a top end of the auxiliary ladder and a ladder frame of the main ladder.

Currently, the rotation structure between the main ladder and the auxiliary ladder of the foldable ladder is substantially completely or mostly exposed to a part outside the ladder frames of the main ladder and the auxiliary ladder, so that the rotation structure is easy to be scratched, collided, and damaged, and sometimes the rotation structure also will be accidentally unlocked, causing safety accidents; in addition, if the rotation structure is exposed too much, after the foldable ladder is folded, the width of the ladder requires a larger space for storage, which also has the problem of storage difficulty for family with small-sized house.

### SUMMARY

An embodiment of the present disclosure provides a foldable ladder, including a main ladder and an auxiliary ladder, wherein a top end of a ladder frame of the auxiliary ladder is connected to a ladder frame of the main ladder through a hinge mechanism;
the hinge mechanism includes a main ladder hinge plate, an auxiliary ladder hinge plate, and a shaft pin lock assembly connecting the main ladder hinge plate and the auxiliary ladder hinge plate, the shaft pin lock assembly is configured to be capable of being in an open state in a first operation condition, to enable the auxiliary ladder hinge plate and the main ladder hinge plate to be rotatable relatively to each other, and being in a locking state in a second operation condition, to lock relative position between the auxiliary ladder hinge plate and the main ladder hinge plate,
wherein the main ladder hinge plate includes a first hinge plate, a second hinge plate, and a third hinge plate that are connected in a “Z” shape in sequence, and in an extending direction of pedal of the main ladder: the first hinge plate is fixed to an outer side surface of the ladder frame of the main ladder, and the first hinge plate is located on an outer side of the third hinge plate; the auxiliary ladder hinge plate is fixed to a top end of the ladder frame of the auxiliary ladder, and the shaft pin lock assembly passes through the third hinge plate and the auxiliary ladder hinge plate and connects the auxiliary ladder hinge plate to the third hinge plate.

### BRIEF DESCRIPTION OF DRAWINGS

In order to more clearly illustrate the technical solutions in specific embodiments of the present disclosure or in the prior art, accompanying drawings which need to be used for description of the specific embodiments or the prior art will be introduced briefly below, and apparently, the drawings in the description below merely show some embodiments of the present disclosure, and a person ordinarily skilled in the art still could obtain other drawings in light of these drawings without creative efforts.

FIG. 1 is an overall structural schematic view of a foldable ladder provided in an embodiment of the present disclosure in a first use angle;

FIG. 2 is a partial structural enlarged view of a part A in FIG. 1;

FIG. 3 is a partial structural enlarged view of a part B in FIG. 1;

FIG. 4 is an overall structural schematic view of a hinge mechanism in the foldable ladder shown in FIG. 1;

FIG. 5 is an exploded structural schematic view of FIG. 4;

FIG. 6 is a front view of the hinge mechanism in the foldable ladder shown in FIG. 1;

FIG. 7 is a front sectional view of the hinge mechanism in the foldable ladder shown in FIG. 1;

FIG. 8 is a schematic view of a using manner of the foldable ladder shown in FIG. 1;

FIG. 9 is an overall structural schematic view of the foldable ladder provided in an embodiment of the present disclosure in a second use angle;

FIG. 10 is a partial structural enlarged view of a part C in FIG. 9;

FIG. 11 is a schematic view of a using manner of the foldable ladder shown in FIG. 9;

FIG. 12 is an overall structural schematic view of the foldable ladder provided in an embodiment of the present disclosure in a second use angle;

FIG. 13 is a partial structural enlarged view of a part D in FIG. 12;

FIG. 14 is a schematic view of a using manner of the foldable ladder shown in FIG. 12; and

FIG. 15 is a schematic view of examples of wall structures to which a ladder cap of the foldable ladder provided in an embodiment of the present disclosure can be adapted.

Reference signs: 100-main ladder; 200-auxiliary ladder; 300-hinge mechanism; 1-main ladder hinge plate; 101-avoiding hole; 102-avoiding groove; 103-main ladder middle perforation; 104-main ladder pin shaft hole; 11-first hinge plate; 12-second hinge plate; 13-third hinge plate; 2-auxiliary ladder hinge plate; 201-auxiliary ladder middle perforation; 202-auxiliary ladder pin shaft hole; 2021-first hole; 2022-second hole; 2023-third hole; 2024-fourth hole; 203-raised limiting groove; 3-locking pin shaft; 31-shaft body; 3101-through hole; 3102-first annular limiting groove; 311-opening pin; 32-end cover; 321-positioning post; 323-steel ball spring; 324-first steel ball; 325-second steel ball; 4-shaft sleeve; 401-steel ball limiting hole; 402-step surface; 403-limiting protrusion; 404-second annular limiting groove; 5-unlocking handle; 6-first elastic retaining ring; 7-second elastic retaining ring; 8-pressure spring; 9-ladder cap; 91-tool groove.

### DETAILED DESCRIPTION OF EMBODIMENTS

In order to make objectives, technical solutions, and advantages of the embodiments of the present disclosure clearer, the technical solutions in the embodiments of the present disclosure will be described clearly and completely below in conjunction with the accompanying drawings in the embodiments of the present disclosure, and apparently, some but not all embodiments of the present disclosure are described. Generally, components in the embodiments of the present disclosure described and shown in the accompanying drawings herein may be arranged and designed in various different configurations.

Therefore, the detailed description below of the embodiments of the present disclosure provided in the accompanying drawings is not intended to limit the scope of protection of the present disclosure, but merely represents chosen embodiments of the present disclosure. Based on the embodiments of the present disclosure, all of other embodiments obtained by those ordinarily skilled in the art without any creative efforts shall fall within the scope of protection of the present disclosure.

It should be noted that similar reference signs and letters represent similar items in the following accompanying drawings, therefore, once a certain item is defined in one accompanying drawing, it is not needed to be further defined or explained in subsequent accompanying drawings.

In the description of the present disclosure, it should be noted that orientation or positional relationships indicated by terms such as “upper”, “lower”, “vertical”, “horizontal”, “inner”, and “outer” are based on orientation or positional relationships as shown in the accompanying drawings, or orientation or positional relationships of an inventive product when being conventionally placed in use, merely for facilitating describing the present disclosure and simplifying the description, rather than indicating or suggesting that related apparatuses or elements have to be in the specific orientation or configured and operated in a specific orientation, therefore, they should not be construed as limitation on the present disclosure. Besides, terms such as “first”, “second”, and “third” are merely for distinctive description, but should not be construed as indicating or implying importance in the relativity.

Moreover, the terms “horizontal”, “vertical” and the like do not mean that the parts are required to be absolutely horizontal or overhanging, but may be slightly inclined. For example, by “horizontal” it merely means that a structure is more horizontal in comparison with “vertical”, rather than being completely horizontal, while the structure can be slightly inclined.

In the description of the present disclosure, it should be further illustrated that, unless otherwise specifically regulated and defined, the terms “provide”, “install”, and “connect” should be understood in a broad sense, for example, a connection may be a fixed connection, a detachable connection, or an integrated connection; it may be a mechanical connection or an electrical connection; it may be direct joining or indirect joining through an intermediate medium, and it also may be inner communication between two elements. For a person ordinarily skilled in the art, specific meanings of the above-mentioned terms in the present disclosure could be understood according to specific circumstances.

An objective of the present disclosure includes, for example, providing a foldable ladder, so as to solve the technical problems that the rotation structure between the main ladder and the auxiliary ladder of the existing foldable ladders is substantially completely or mostly exposed outside, is easy to be scratched, collided, and damaged or accidentally unlocked to cause safety accidents and the existing foldable ladders are hard to store.

In order to achieve the above objective, an embodiment of the present disclosure adopts the following technical solution.

An embodiment of the present disclosure provides a foldable ladder, including a main ladder and an auxiliary ladder, and a top end of a ladder frame of the auxiliary ladder being connected to a ladder frame of the main ladder through a hinge mechanism,
wherein the hinge mechanism includes a main ladder hinge plate, an auxiliary ladder hinge plate, and a shaft pin lock assembly connecting the main ladder hinge plate and the auxiliary ladder hinge plate, the shaft pin lock assembly is configured to be capable of being in an open state in a first operation condition, so as to enable the auxiliary ladder hinge plate and the main ladder hinge plate to be rotatable relatively to each other, and being in a locking state in a second operation condition, so as to lock the relative position between the auxiliary ladder hinge plate and the main ladder hinge plate,
wherein the main ladder hinge plate includes a first hinge plate, a second hinge plate, and a third hinge plate connected in a “Z” shape in sequence, and in an extending direction of pedal of the main ladder, the first hinge plate is fixed to an outer side surface of the ladder frame of the main ladder, and the first hinge plate is located on an outer side of the third hinge plate; the auxiliary ladder hinge plate is fixed to a top end of the ladder frame of the auxiliary ladder, and the shaft pin lock assembly passes through the third hinge plate and the auxiliary ladder hinge plate and connects the auxiliary ladder hinge plate to the third hinge plate.

In the embodiment of the present disclosure, by providing such a structure that the main ladder hinge plate includes the first hinge plate, the second hinge plate, and the third hinge plate connected in a “Z” shape in sequence, and in the extending direction of pedal of the main ladder: the first hinge plate is fixed to the outer side surface of the ladder frame of the main ladder, and the first hinge plate is located on the outer side of the third hinge plate; the auxiliary ladder hinge plate is fixed to the top end of the ladder frame of the auxiliary ladder; and the shaft pin lock assembly passes through the third hinge plate and the auxiliary ladder hinge plate and connects the auxiliary ladder hinge plate to the third hinge plate, in the extending direction of pedal of the main ladder, an accommodation space can be formed between the outer side of the main ladder and the outer side of the auxiliary ladder, and the accommodation space can accommodate the hinge mechanism as the rotation structure, such that the shaft pin lock assembly is substantially completely or mostly accommodated inside the accommodation space, and a space occupied by a part of the shaft pin lock assembly exposed outside the ladder frames of the main ladder and the auxiliary ladder is reduced or even eliminated, facilitating the accommodation, meanwhile, preventing the shaft pin lock assembly from being exposed outside to cause damage, reducing the recondition frequency, prolonging the service life of the shaft pin lock assembly, and further extending the service life of the foldable ladder.

In summary, the foldable ladder provided by the present embodiment solves the technical problems that the rotation structure between the main ladder and the auxiliary ladder of the existing foldable ladders is substantially completely or mostly exposed outside, is easy to be scratched, collided, and damaged or accidentally unlocked to cause safety accidents and the existing foldable ladders are hard to store, which has a good application prospect.

In an optional embodiment of the embodiments of the present disclosure, a hinge plate mounting groove is provided on a top end surface of the ladder frame of the auxiliary ladder, and a lower end of the auxiliary ladder hinge plate is inserted into and fixed in the hinge plate mounting groove.

In an optional embodiment of the embodiments of the present disclosure, in the main ladder hinge plate:
the first hinge plate and/or the second hinge plate are/is provided with avoiding holes for avoiding a fixing member for a pedal; and/or the first hinge plate is provided with an avoiding groove for avoiding a fixing member for a pedal on a side facing the ladder frame of the main ladder; and/or the second hinge plate is provided with an avoiding groove for avoiding a fixing member for a pedal on a side facing the ladder frame of the main ladder.

In an optional embodiment of the embodiments of the present disclosure, the second operation condition includes at least three locking states, and in each of the locking states, the auxiliary ladder hinge plate has different angles with the main ladder hinge plate.

In an optional embodiment of the embodiments of the present disclosure, one of the at least three locking states is taken as an initial locking state, and there is another locking state satisfying an angle of the auxiliary ladder hinge plate with respect to the main ladder hinge plate=an angle of the auxiliary ladder hinge plate with respect to the main ladder hinge plate in the initial locking state+180 degrees.

In an optional embodiment of the embodiments of the present disclosure, the shaft pin lock assembly includes a locking pin shaft, a shaft sleeve, a pressure spring, an unlocking handle, a first elastic retaining ring, and a second elastic retaining ring, wherein
the locking pin shaft includes a shaft body and an end cover connected to a first end of the shaft body, and the end cover is provided with positioning posts parallel to the shaft body on a side facing a second end of the shaft body; a first annular limiting groove extending in a radial circumferential direction of the shaft body is provided at the second end of the shaft body; a through hole radially passing through the shaft body along the shaft body is provided on the shaft body in a position between the end cover and the first annular limiting groove, a steel ball spring, a first steel ball, and a second steel ball are provided inside the through hole, and the first steel ball and the second steel ball respectively abut against two ends of the steel ball spring;
the shaft sleeve is sleeved over the shaft body and located on a side of the first annular limiting groove close to the first end of the shaft body, the shaft sleeve includes a first hollow cylindrical segment and a second hollow cylindrical segment connected to each other, the first hollow cylindrical segment is close to the first end of the locking pin shaft, the second hollow cylindrical segment is close to the second end of the locking pin shaft, and the first hollow cylindrical segment has a diameter greater than that of the second hollow cylindrical segment; a circumferential surface of the second hollow cylindrical segment is provided with a plurality of steel ball limiting holes arranged at intervals along a radial circumferential direction of the second hollow cylindrical segment; and a second annular limiting groove is further provided on an outer circumferential surface of the second hollow cylindrical segment on a side of the steel ball limiting hole away from the first hollow cylindrical segment, and the second annular limiting groove extends along a radial circumferential direction of the second hollow cylindrical segment;
the third hinge plate of the main ladder hinge plate is provided with a main ladder middle perforation and main ladder pin shaft holes, the auxiliary ladder hinge plate is provided with an auxiliary ladder middle perforation and a plurality of auxiliary ladder pin shaft holes disposed around the auxiliary ladder middle perforation, along a direction extending from the first end to the second end of the shaft body of the locking pin shaft, the second hollow cylindrical segment of the shaft sleeve passes through the main ladder middle perforation and the auxiliary ladder middle perforation in sequence, and the third hinge plate abuts against a step surface formed by a part where the first hollow cylindrical segment and the second hollow cylindrical segment are connected with each other, the positioning posts on the end cover of the locking pin shaft pass through the main ladder pin shaft holes, and the auxiliary ladder hinge plate is connected to the shaft sleeve in a manner of synchronously rotating with the shaft sleeve, moreover, the auxiliary ladder hinge plate is located on a side of the second annular limiting groove close to the first end of the shaft body; and
the first elastic retaining ring is provided in the first annular limiting groove, the second elastic retaining ring is provided in the second annular limiting groove, and the pressure spring is sleeved over the shaft body of the locking pin shaft and is limited between the first elastic retaining ring and the second elastic retaining ring, wherein
in a locking operation condition, the first steel ball and the second steel ball are respectively limited in corresponding steel ball limiting holes on the shaft sleeve under the elastic-force effect of the steel ball spring, and the positioning posts on the end cover of the locking pin shaft pass through the main ladder pin shaft holes and the corresponding auxiliary ladder pin shaft holes; and
when the unlocking handle is subjected to an external pressing force, the pressure spring is compressed to push the locking pin shaft to slide as a whole towards a direction of the first end of the shaft body, and the positioning posts on the end cover of the locking pin shaft exit the auxiliary ladder pin shaft holes, and the auxiliary ladder hinge plate can be rotated relatively to the main ladder hinge plate.

In an optional embodiment of the embodiments of the present disclosure, in the locking pin shaft, there are two positioning posts symmetrically provided with respect to the shaft body.

In an optional embodiment of the embodiments of the present disclosure, a limiting protrusion is provided on an outer circumferential surface of the second hollow cylindrical segment, the limiting protrusion is located between the steel ball limiting hole and the second annular limiting groove, a raised limiting groove is provided on an inner wall of the auxiliary ladder middle perforation, and the limiting protrusion is snapped inside the raised limiting groove.

In an optional embodiment of the embodiments of the present disclosure, in the locking pin shaft, the end cover and the shaft body are fixedly connected together through an opening pin.

In an optional embodiment of the embodiments of the present disclosure, a ladder cap is provided at a top end of the ladder frame of the main ladder; and an upper surface of the ladder cap is provided with a tool groove, and/or the ladder cap has a width of 140 mm-160 mm.

In an optional embodiment of the embodiments of the present disclosure, the auxiliary ladder pin shaft holes include a first hole, a second hole, a third hole, and a fourth hole arranged around the auxiliary ladder middle perforation, the first hole and the fourth hole are symmetrically arranged with respect to the auxiliary ladder middle perforation, and the second hole and the third hole are symmetrical with respect to the auxiliary ladder middle perforation.

In an optional embodiment of the embodiments of the present disclosure, the second operation condition includes three locking states: a first locking state, a second locking state, and a third locking state, wherein in the first locking state, the auxiliary ladder pin shaft holes through which the two positioning posts pass are the first hole and the fourth hole.

In an optional embodiment of the embodiments of the present disclosure, the second operation condition includes three locking states: a first locking state, a second locking state, and a third locking state, wherein in the second locking state, the auxiliary ladder pin shaft holes through which the two positioning posts pass are the second hole and the third hole.

In an optional embodiment of the embodiments of the present disclosure, the second operation condition includes three locking states: a first locking state, a second locking state, and a third locking state, wherein in the third locking state, the auxiliary ladder pin shaft holes through which the two positioning posts pass are the first hole and the fourth hole, and the auxiliary ladder pin shaft holes through which the two positioning posts pass are exchanged in position.

In an optional embodiment of the embodiments of the present disclosure, on two opposite surfaces of a circumferential surface of the shaft sleeve, three steel ball limiting holes are arranged on one surface, and another three steel ball limiting holes, symmetrical with the three steel ball limiting holes with respect to the shaft body, are arranged on the other surface.

In an optional embodiment of the embodiments of the present disclosure, there are two main ladder pin shaft holes symmetrically arranged with respect to the main ladder middle perforation.

The technical effects of the embodiments of the present disclosure include, for example:
by providing such a structure that the main ladder hinge plate includes the first hinge plate, the second hinge plate, and the third hinge plate connected in a “Z” shape in sequence, and in the extending direction of pedal of the main ladder: the first hinge plate is fixed to the outer side surface of the ladder frame of the main ladder, and the first hinge plate is located on the outer side of the third hinge plate; the auxiliary ladder hinge plate is fixed to the top end of the ladder frame of the auxiliary ladder; and the shaft pin lock assembly passes through the third hinge plate and the auxiliary ladder hinge plate and connects the auxiliary ladder hinge plate to the third hinge plate, in the extending direction of pedal of the main ladder, an accommodation space can be formed between the outer side of the main ladder and the outer side of the auxiliary ladder, and the accommodation space can accommodate the hinge mechanism as the rotation structure, such that the shaft pin lock assembly is substantially completely or mostly accommodated inside the accommodation space, and a space occupied by a part of the shaft pin lock assembly exposed outside the ladder frames of the main ladder and the auxiliary ladder is reduced or even eliminated, facilitating the accommodation, meanwhile, preventing the shaft pin lock assembly from being exposed to cause damage, reducing the maintenance frequency, prolonging the service life of the shaft pin lock assembly, further extending the service life of the foldable ladder, and having a good application prospect.

Some embodiments of the present disclosure are described in detail below in combination with the drawings. The following embodiments and features in the embodiments may be combined with each other without conflict.

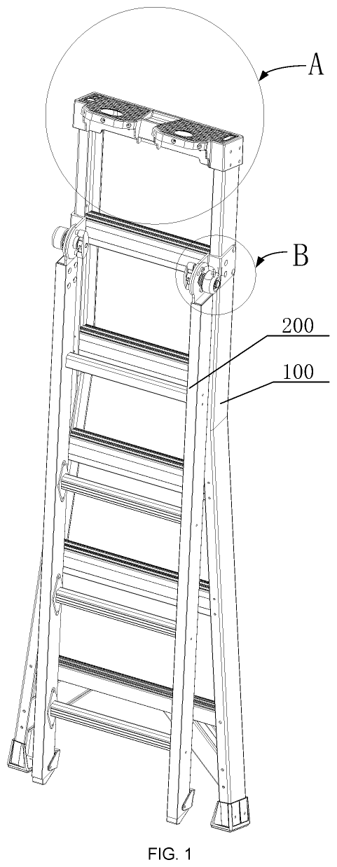

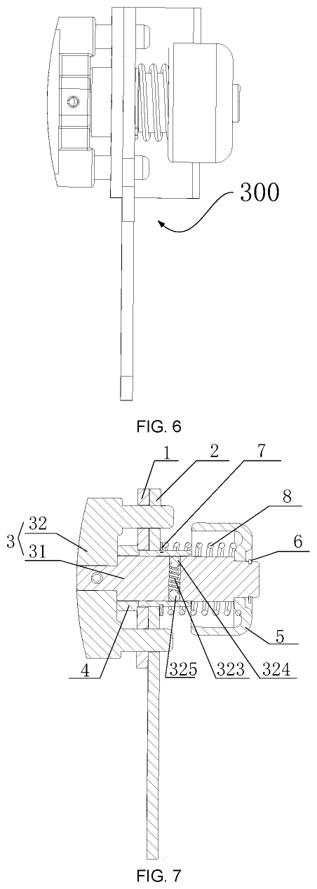

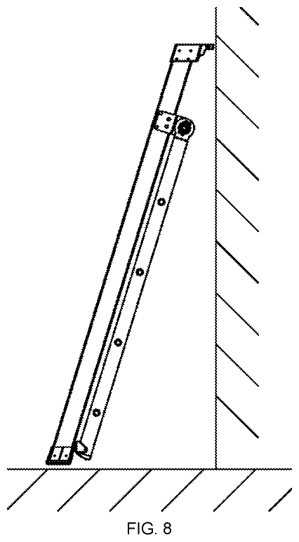

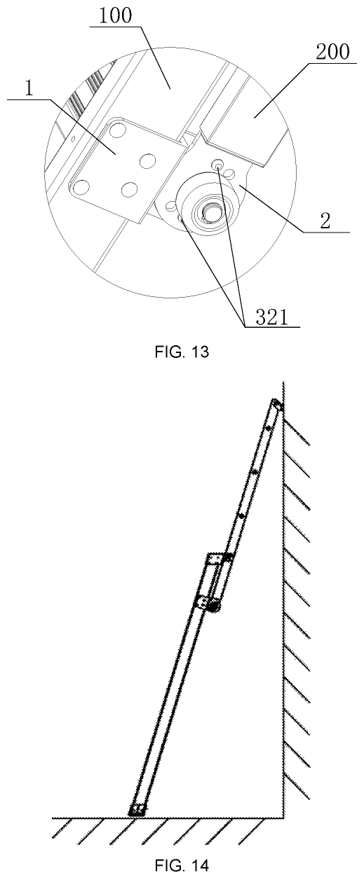

The present embodiment provides a foldable ladder. Referring to FIG. 1 to FIG. 15, the foldable ladder includes a main ladder 100 and an auxiliary ladder 200, and a top end of a ladder frame of the auxiliary ladder 200 is connected to a ladder frame of the main ladder 100 through a hinge mechanism 300; and the hinge mechanism 300 includes a main ladder hinge plate 1, an auxiliary ladder hinge plate 2, and a shaft pin lock assembly connecting the main ladder hinge plate 1 and the auxiliary ladder hinge plate 2. The shaft pin lock assembly is configured to be capable of being in an open state in a first operation condition, to enable the auxiliary ladder hinge plate 2 and the main ladder hinge plate 1 to be rotatable relatively to each other, and in a locking state in the second operation condition, to lock the relative position between the auxiliary ladder hinge plate 2 and the main ladder hinge plate 1. In the above, in particular, as shown in FIG. 3 to FIG. 5, the main ladder hinge plate 1 includes a first hinge plate 11, a second hinge plate 12, and a third hinge plate 13 sequentially connected in a “Z” shape, and in an extending direction of pedal of the main ladder 100: the first hinge plate 11 is fixed to an outer side surface of the ladder frame of the main ladder 100, and the first hinge plate 11 is located on an outer side of the third hinge plate 13; the auxiliary ladder hinge plate 2 is fixed to a top end of the ladder frame of the auxiliary ladder 200, and the shaft pin lock assembly passes through the third hinge plate 13 and the auxiliary ladder hinge plate 2 and connects the auxiliary ladder hinge plate 2 to the third hinge plate 13.

In the present embodiment, by providing such a structure that the main ladder hinge plate 1 includes the first hinge plate 11, the second hinge plate 12, and the third hinge plate 13 that are connected in a “Z” shape in sequence, and in the extending direction of pedal of the main ladder 100: the first hinge plate 11 is fixed to the outer side surface of the ladder frame of the main ladder 100, and the first hinge plate 11 is located on the outer side of the third hinge plate 13; the auxiliary ladder hinge plate 2 is fixed to the top end of the ladder frame of the auxiliary ladder 200, and the shaft pin lock assembly passes through the third hinge plate 13 and the auxiliary ladder hinge plate 2 and connects the auxiliary ladder hinge plate 2 to the third hinge plate 13, in the extending direction of pedal of the main ladder 100, an accommodation space is formed between the outer side of the main ladder 100 and the outer side of the auxiliary ladder 200, and the accommodation space can accommodate the hinge mechanism 300 as the rotation structure, such that the shaft pin lock assembly is substantially completely or mostly accommodated inside the accommodation space, and a space occupied by a part of the shaft pin lock assembly exposed outside the ladder frames of the main ladder and the auxiliary ladder is reduced or even eliminated, facilitating the accommodation, meanwhile, preventing the shaft pin lock assembly from being exposed to cause damage, reducing the repair frequency, prolonging the service life of the shaft pin lock assembly, and further extending the service life of the foldable ladder.

In summary, the foldable ladder provided by the present embodiment alleviates the technical problems that the rotation structure between the main ladder and the auxiliary ladder of the existing foldable ladders is substantially completely or mostly exposed, which is easy to be scratched, collided, and damaged or accidentally unlocked to cause safety accidents and the existing foldable ladders are hard to store, which has a good application prospect.

In the present embodiment, there are a plurality of specific manners of fixing the auxiliary ladder hinge plate 2 to the top end of the ladder frame of the auxiliary ladder 200, for example and without limitation, as shown in FIG. 1 and FIG. 3, a hinge plate mounting groove is provided on a top end surface of the ladder frame of the auxiliary ladder 200, and a lower end of the auxiliary ladder hinge plate 2 is inserted into and fixed in the hinge plate mounting groove by interference fit or bonding or by fixing members such as screws or in other manners, achieving the effect of easy disassembly and assembly. Without doubt, in some other optional embodiments of the present embodiment, it is also feasible that the lower end of the auxiliary ladder hinge plate 2 is welded or integrally molded on the top end of the ladder frame of the auxiliary ladder 200. The specific manner of fixing the auxiliary ladder hinge plate 2 to the top end of the ladder frame of the auxiliary ladder 200 is not limited in the present disclosure, and the specific manner may be selected according to actual needs.

In some optional embodiments of the present embodiment, as shown in FIG. 5, in the main ladder hinge plate 1: the first hinge plate 11 and/or the second hinge plate 12 are/is provided with avoiding holes 101 for avoiding a pedal fixing members; and/or the first hinge plate 11 is provided with an avoiding groove for avoiding the pedal fixing members on a side facing the ladder frame of the main ladder 100; and/or the second hinge plate 12 is provided with an avoiding groove 102 for avoiding the pedal fixing members on a side facing the ladder frame of the main ladder 100. By providing the above avoiding holes 101 and/or avoiding groove 102, the fixing members such as screws used for fixing the pedal and the ladder frame of the main ladder 100 can be avoided, so that the main ladder hinge plate 1 is better attached to the ladder frame of the main ladder 100, further increasing the connection strength between the main ladder hinge plate 1 and the ladder frame of the main ladder 100. The specific manner of fixedly connecting the pedal and the ladder frame of the main ladder 100 is not limited in the present disclosure, for example, the pedal and the ladder frame of the main ladder 100 may be detachably connected by fixing members such as screws or welded or integrally molded, and the specific manner may be selected according to actual needs.

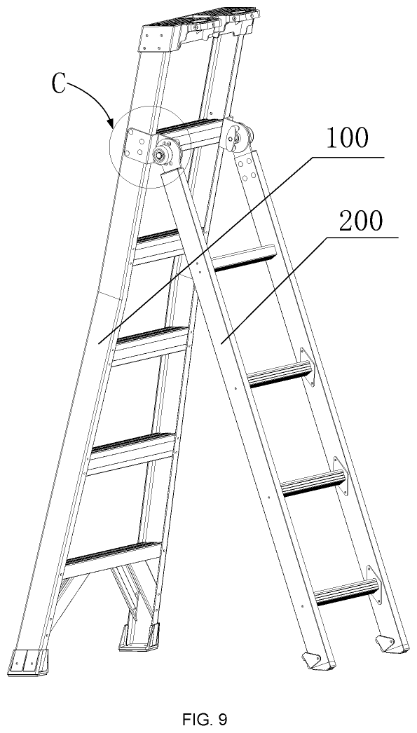

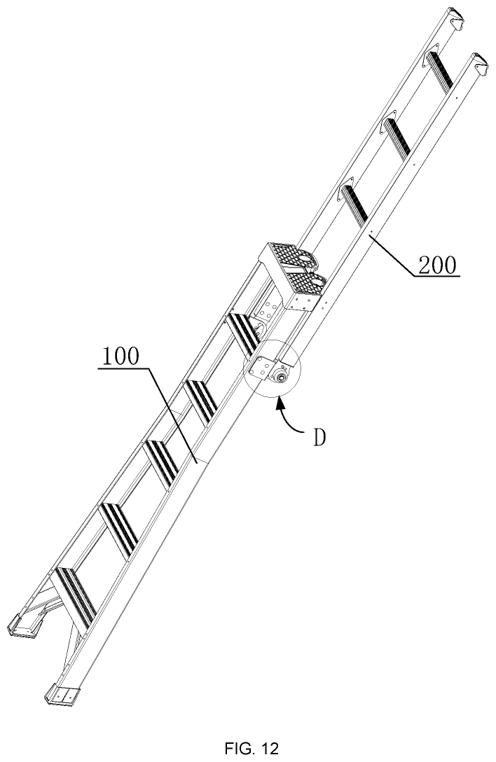

In some optional embodiments of the present embodiment, the second operation condition above includes at least three locking states. In each locking state, the auxiliary ladder hinge plate 2 has different angles with the main ladder hinge plate 1, and preferably, one of the at least three locking states is taken as an initial locking state, and there is another locking state satisfying an angle of the auxiliary ladder hinge plate 2 with respect to the main ladder hinge plate 1=an angle of the auxiliary ladder hinge plate 2 with respect to the main ladder hinge plate 1 in the initial locking state+180 degrees. Specifically, a first locking state is as shown in FIG. 1 to FIG. 8, a second locking state is as shown in FIG. 9 to FIG. 11, and a third locking state is as shown in FIG. 12 to FIG. 14, wherein the first locking state is the initial locking state, in the third locking state, the angle of the auxiliary ladder hinge plate 2 with respect to the main ladder hinge plate 1 is equal to the angle of the auxiliary ladder hinge plate 2 with respect to the main ladder hinge plate 1 in the initial locking state plus 180 degrees, so as to realize the function of 180-degree flip relative to the main ladder 100 to increase an total effective use length of the ladder, the first locking state and the second locking state are used with the total effective use length of the main ladder 100, and in the second locking state, the main ladder 100 and the auxiliary ladder 200 are in a form of “herringbone” ladder.

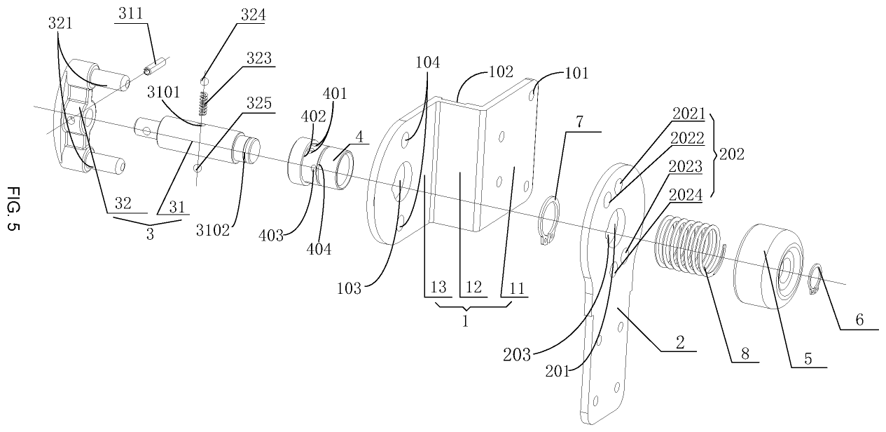

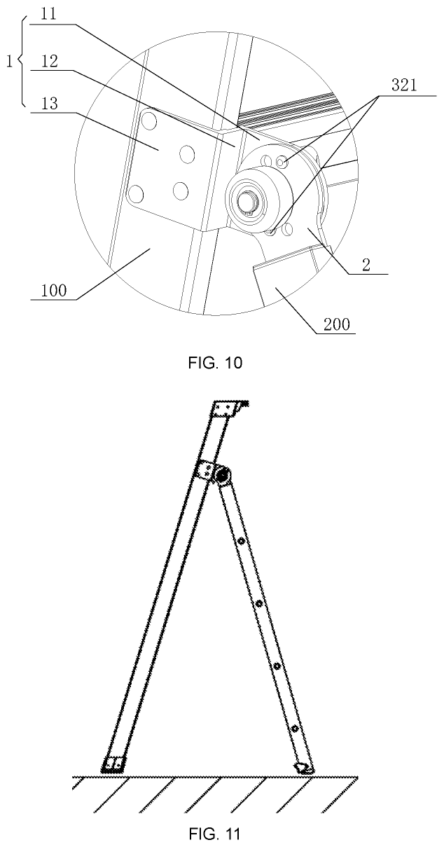

In multiple optional embodiments of the present embodiment, the shaft pin lock assembly of the foldable ladder has a plurality of specific optional structural forms, wherein more preferably and without limitation, as shown in FIG. 3 to FIG. 7, in combination with FIG. 1, FIG. 10, and FIG. 13, the shaft pin lock assembly includes a locking pin shaft 3, a shaft sleeve 4, a pressure spring 8, an unlocking handle 5, a first elastic retaining ring 6, and a second elastic retaining ring 7. With a focus on FIG. 4 to FIG. 7, the above locking pin shaft 3 includes a shaft body 31 and an end cover 32 connected to a first end of the shaft body 31, and the end cover 32 is provided with positioning posts 321 parallel to the shaft body 31 on a side facing a second end of the shaft body 31; a first annular limiting groove 3102 extending in a radial circumferential direction of the shaft body 31 is provided at the second end of the shaft body 31; and a through hole 3101 radially passing through the shaft body 31 along the shaft body 31 is provided on the shaft body 31 in a position between the end cover 32 and the first annular limiting groove 3102, a steel ball spring 323, a first steel ball 324, and a second steel ball 325 are provided inside the through hole 3101, and the first steel ball 324 and the second steel ball 325 respectively abut against two ends of the steel ball spring 323. The shaft sleeve 4 is sheathed outside the shaft body 31 and located on a side of the first annular limiting groove 3102 close to the first end of the shaft body 31, the shaft sleeve 4 includes a first hollow cylindrical segment and a second hollow cylindrical segment connected to each other, the first hollow cylindrical segment is close to the first end of the locking pin shaft 3, the second hollow cylindrical segment is close to the second end of the locking pin shaft 3, and the first hollow cylindrical segment has a diameter greater than that of the second hollow cylindrical segment; a circumferential surface of the second hollow cylindrical segment is provided with a plurality of steel ball limiting holes 401 arranged at intervals along a radial circumferential direction of the second hollow cylindrical segment; a second annular limiting groove 404 is further provided on an outer circumferential surface of the second hollow cylindrical segment and located on a side of the steel ball limiting hole 401 away from the first hollow cylindrical segment, and the second annular limiting groove 404 extends along a radial circumferential direction of the second hollow cylindrical segment. The third hinge plate 13 of the main ladder hinge plate 1 is provided with a main ladder middle perforation 103 and main ladder pin shaft holes 104, the auxiliary ladder hinge plate 2 is provided with an auxiliary ladder middle perforation 201 and a plurality of auxiliary ladder pin shaft holes 202 disposed around the auxiliary ladder middle perforation 201. Along a direction extending from the first end to the second end of the shaft body 31 of the locking pin shaft 3, the second hollow cylindrical segment of the shaft sleeve 4 passes through the main ladder middle perforation 103 and the auxiliary ladder middle perforation 201 in sequence, and the third hinge plate 13 abuts against a step surface 402 formed by a part where the first hollow cylindrical segment and the second hollow cylindrical segment are connected with each other. The positioning posts 321 on the end cover 32 of the locking pin shaft 3 pass through the main ladder pin shaft holes 104, and the auxiliary ladder hinge plate 2 is connected to the shaft sleeve 4 in a manner of synchronously rotating with the shaft sleeve 4, and moreover, the auxiliary ladder hinge plate 2 is located on a side of the second annular limiting groove 404 close to the first end of the shaft body 31. The first elastic retaining ring 6 is provided in the first annular limiting groove 3102, the second elastic retaining ring 7 is provided in the second annular limiting groove 404, and the pressure spring 8 is sheathed outside the shaft body 31 of the locking pin shaft 3 and is limited between the first elastic retaining ring 6 and the second elastic retaining ring 7.

In a locking operation condition, the first steel ball 324 and the second steel ball 325 are respectively limited in corresponding steel ball limiting holes 401 on the shaft sleeve 4 under the elastic-force effect of the steel ball spring 323, and the positioning posts 321 on the end cover 32 of the locking pin shaft 3 pass through the main ladder pin shaft holes 104 and the corresponding auxiliary ladder pin shaft holes 202. When the unlocking handle 5 is subjected to an external pressing force, the pressure spring 8 is compressed to push the locking pin shaft 3 to slide as a whole towards the direction of the first end of the shaft body 31, and the positioning posts 321 on the end cover 32 of the locking pin shaft 3 exit the auxiliary ladder pin shaft holes 202, and the auxiliary ladder hinge plate 2 can be rotated relatively to the main ladder hinge plate 1.

In the above, the specific arrangement number of the main ladder pin shaft holes 104 and the arrangement angle relative to the main ladder middle perforation 103, the specific arrangement number of the auxiliary ladder pin shaft holes 202 and the arrangement angle relative to the auxiliary ladder middle perforation 201, and the arrangement number and spacing of the steel ball limiting holes 401 may be adaptively set according to the arrangement number and arrangement positions of positioning posts 321, so as to be adapted to various locking angles of rotation of the auxiliary ladder hinge plate 2 relative to the main ladder hinge plate 1. For example and without limitation, there are three locking states, corresponding to three locking angles. The first locking state is as shown in FIG. 1 to FIG. 8, the second locking state is as shown in FIG. 9 to FIG. 11, and the third locking state is as shown in FIG. 12 to FIG. 14. Referring to FIG. 5, in the locking pin shaft 3, there are two positioning posts 321 symmetrically provided with respect to the shaft body 31; on two opposite surfaces of a circumferential surface of the shaft sleeve 4, three steel ball limiting holes 401 are arranged on one surface, and another three steel ball limiting holes 401 symmetrical with the aforementioned three steel ball limiting holes 401 with respect to the shaft body 31 are arranged on the other surface; and there are two main ladder pin shaft holes 104 symmetrically arranged with respect to the main ladder middle perforation 103, the auxiliary ladder pin shaft holes 202 include a first hole 2021, a second hole 2022, a third hole 2023, and a fourth hole 2024 arranged around the auxiliary ladder middle perforation 201, the first hole 2021 and the fourth hole 2024 are symmetrical with respect to the auxiliary ladder middle perforation 201, and the second hole 2022 and the third hole 2023 are symmetrical with respect to the auxiliary ladder middle perforation 201.

In the three locking states, the first steel ball 324 and the second steel ball 325 are respectively limited in two steel ball limiting holes 401 on the shaft sleeve 4 being symmetrical with respect to the shaft body 31 under the elastic-force effect of the steel ball spring 323, and the two positioning posts 321 on the end cover 32 of the locking pin shaft 3 respectively correspondingly pass through the above two main ladder pin shaft holes 104 symmetrical with respect to the main ladder middle perforation 103 and two corresponding auxiliary ladder pin shaft holes 202 symmetrical with respect to the auxiliary ladder middle perforation 201, wherein in the first locking state, as shown in FIG. 3, in combination with FIG. 5, the auxiliary ladder pin shaft holes 202 through which the two positioning posts 321 pass are the first hole 2021 and the fourth hole 2024; in the second locking state, as shown in FIG. 10, in combination with FIG. 5, the auxiliary ladder pin shaft holes 202 through which the two positioning posts 321 pass are the second hole 2022 and the third hole 2023; and in the third locking state, as shown in FIG. 13, in combination with FIG. 5, the auxiliary ladder pin shaft holes 202 through which the two positioning posts 321 pass are the first hole 2021 and the fourth hole 2024, but the auxiliary ladder pin shaft holes 202 through which the two positioning posts 321 pass are exchanged in position.

When the switching operation is performed between any two locking states, the unlocking handle 5 is pressed towards the direction of the first end of the shaft body 31, and then the pressure spring 8 is compressed to push the locking pin shaft 3 to slide as a whole toward the direction of the first end of the shaft body 31, the positioning posts 321 on the end cover 32 of the locking pin shaft 3 exit the auxiliary ladder pin shaft holes 202, but still pass through the main ladder pin shaft holes 104, and the auxiliary ladder hinge plate 2 is rotatable relatively to the main ladder hinge plate 1. As the auxiliary ladder hinge plate 2 is connected to the shaft sleeve 4 in a manner of synchronously rotating with the shaft sleeve 4, when the auxiliary ladder hinge plate 2 is rotated, the shaft sleeve 4 is rotated therewith, and before being rotated in place, the first steel ball 324 and the second steel ball 325 respectively abut against an inner peripheral wall of the shaft sleeve 4 under the elastic-force effect of the steel ball spring 323, the positioning posts 321 pass through the main ladder pin shaft holes 104 and abut against a surface of the auxiliary ladder hinge plate 2 facing the end cover 32, and a part of the auxiliary ladder hinge plate 2 without being provided with holes blocks the positioning posts 321 from sliding toward the direction of the second end of the shaft body 31 under an elastic restoring force of the pressure spring 8; after being rotated in place, the first steel ball 324 and the second steel ball 325 are respectively limited in the corresponding steel ball limiting holes 401 on the shaft sleeve 4 under the elastic force of the steel ball spring 323, and under the elastic restoring force of the pressure spring 8, the positioning posts 321 pass through the corresponding auxiliary ladder pin shaft holes 202.

The hinge mechanism 300 used in the present embodiment is stable in structure, easy to operate, and not easy to fail, which is beneficial to improve use safety and use convenience of the foldable ladder.

In the present embodiment, there are a plurality of specific manners of connecting the auxiliary ladder hinge plate 2 to the shaft sleeve 4 in a manner of synchronous rotation with the shaft sleeve 4, for example and without limitation, the auxiliary ladder hinge plate 2 is key-jointed or bonded or welded or integrally molded with the shaft sleeve 4, wherein preferably, without limitation, as shown in FIG. 5, a limiting protrusion 403 is provided on an outer circumferential surface of the second hollow cylindrical segment of the shaft sleeve 4, the limiting protrusion 403 is located between the steel ball limiting hole 401 and the second annular limiting groove 404, a raised limiting groove 203 is provided on an inner wall of the auxiliary ladder middle perforation 201, and the limiting protrusion 403 is snapped in the raised limiting groove 203. A specific manner of specifically connecting the auxiliary ladder hinge plate 2 and the shaft sleeve 4 is not limited in the present disclosure, as long as the auxiliary ladder hinge plate 2 can be rotated synchronously with the shaft sleeve 4, and the specific manner can be selected according to actual needs.

In addition, in the present embodiment, there are also a plurality of specific manners of connecting the end cover 32 and the shaft body 31 in the locking pin shaft 3, for example and without limitation, welding or bonding or integrally molding the end cover 32 and the shaft body 31, and more preferably, without limitation, as shown in FIG. 5, the end cover 32 and the shaft body 31 are fixedly connected together through an opening pin 311.

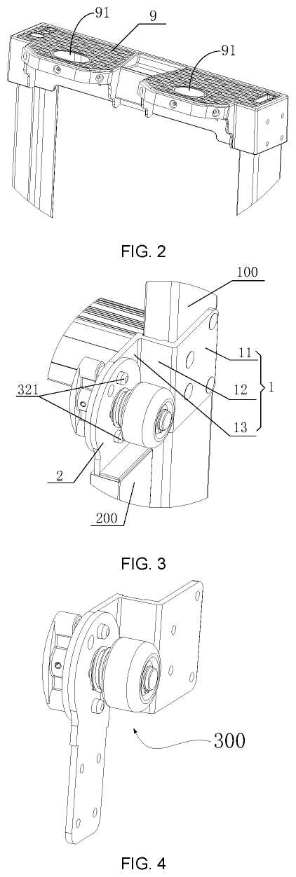

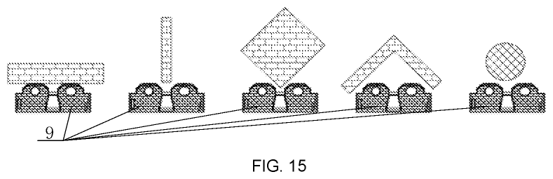

In addition, for convenience of use, in the present embodiment, with reference to FIG. 1, FIG. 2, FIG. 9, and FIG. 12, a ladder cap 9 is provided at the top end of the ladder frame of the main ladder 100, wherein an upper surface of the ladder cap 9 is provided with a tool groove 91, and/or the ladder cap 9 has a width of 140 mm-160 mm. The ladder cap 9 is matched with the wall in a manner as shown in FIG. 15, which can be used for many common wall surface structures, for example, flat wall, external corner wall, internal corner wall, square column wall, cylindrical wall. The numerical range 140 mm-160 mm of the width of the ladder cap 9 is the optimal data obtained by the applicant after a plurality of trials, which is increased by about 50 mm with respect to the conventional ladder caps, and has a larger surface area. When stepping on the ladder cap 9 to work, people's center of gravity is more stable, and people's feet are less prone to fatigue and are safer; moreover, the ladder cap 9 may be correspondingly provided with more tool grooves 91 than a common ladder cap, and it is more convenient to use. The widened ladder cap can hold slightly larger auxiliary tools such as paint buckets when in use to assist workers in work, and further improve the working efficiency of workers.

Finally, it should be indicated that:
1, all “and/or” referred to in the present description respectively represent a simultaneous or alternative or selective combination arrangement between a structure specifically recited before the corresponding “and/or” and a structure specifically recited after the corresponding “and/or”; and
2, various embodiments in the present description are described in a progressive manner, each embodiment focuses on differences from other embodiments, and the same or similar parts between various embodiments may refer to each other; various embodiments above in the present description are merely used for illustrating the technical solutions of the present disclosure, rather than limiting the present disclosure; although the detailed description is made to the present disclosure with reference to various preceding embodiments, those ordinarily skilled in the art should understand that they still could modify the technical solutions recited in various preceding embodiments, or make equivalent substitutions to some or all of the technical features therein; and these modifications or substitutions do not make the corresponding technical solutions essentially depart from the scope of the technical solutions of various embodiments of the present disclosure.

### INDUSTRIAL APPLICABILITY

The foldable ladder provided in the present disclosure can solve the technical problems that the rotation structure between the main ladder and the auxiliary ladder of the existing foldable ladders is substantially completely or mostly exposed outside, which is easy to be scratched, collided, and damaged or accidentally unlocked to cause safety accidents and the existing foldable ladders are hard to store, which has a good application prospect.

Specifically, by providing such a structure that the main ladder hinge plate includes the first hinge plate, the second hinge plate, and the third hinge plate connected in a “Z” shape in sequence, and in the extending direction of pedal of the main ladder: the first hinge plate is fixed to the outer side surface of the ladder frame of the main ladder, and the first hinge plate is located on the outer side of the third hinge plate; the auxiliary ladder hinge plate is fixed to the top end of the ladder frame of the auxiliary ladder, and the shaft pin lock assembly passes through the third hinge plate and the auxiliary ladder hinge plate and connects the auxiliary ladder hinge plate to the third hinge plate, in the extending direction of pedal of the main ladder, an accommodation space can be formed between the outer side of the main ladder and the outer side of the auxiliary ladder, and the accommodation space can accommodate the hinge mechanism as the rotation structure, such that the shaft pin lock assembly is substantially completely or mostly accommodated inside the accommodation space, and a space occupied by a part of the shaft pin lock assembly exposed outside the ladder frames of the main ladder and the auxiliary ladder is reduced or even eliminated, facilitating the accommodation, meanwhile, preventing the shaft pin lock assembly from being exposed to cause damage, reducing the maintenance frequency, prolonging the service life of the shaft pin lock assembly, and further extending the service life of the foldable ladder.

What is claimed is:

1. A foldable ladder, comprising a main ladder and an auxiliary ladder, wherein a top end of a ladder frame of the auxiliary ladder is connected to a ladder frame of the main ladder through a hinge mechanism,
wherein the hinge mechanism comprises a main ladder hinge plate, an auxiliary ladder hinge plate, and a shaft pin lock assembly connecting the main ladder hinge plate and the auxiliary ladder hinge plate, wherein the shaft pin lock assembly is configured to be capable of being in an open state in a first operation condition, so as to enable the auxiliary ladder hinge plate and the main ladder hinge plate to be rotatable relatively to each other, and being in a locking state in a second operation condition, so as to lock a relative position between the auxiliary ladder hinge plate and the main ladder hinge plate,
wherein the main ladder hinge plate comprises a first hinge plate, a second hinge plate, and a third hinge plate that are sequentially connected in a “Z” shape, and in an extending direction of a pedal of the main ladder, the first hinge plate is fixed to an outer side surface of the ladder frame of the main ladder, and the first hinge plate is located on an outer side of the third hinge plate; and the auxiliary ladder hinge plate is fixed to the top end of the ladder frame of the auxiliary ladder, and the shaft pin lock assembly passes through the third hinge plate and the auxiliary ladder hinge plate and connects the auxiliary ladder hinge plate to the third hinge plate.

2. The foldable ladder according to claim 1, wherein a hinge plate mounting groove is provided on a top end surface of the ladder frame of the auxiliary ladder, and a lower end of the auxiliary ladder hinge plate is inserted into and fixed in the hinge plate mounting groove.

3. The foldable ladder according to claim 1, wherein
in the main ladder hinge plate,
avoiding holes for avoiding a pedal fixing member are provided on the first hinge plate and/or the second hinge plate; and/or
an avoiding groove for avoiding a pedal fixing member is provided on a side of the first hinge plate facing the ladder frame of the main ladder; and/or
an avoiding groove for avoiding a pedal fixing member is provided on a side of the second hinge plate facing the ladder frame of the main ladder.

4. The foldable ladder according to claim 1, wherein the second operation condition comprises at least three locking states, and in each of the locking states, the auxiliary ladder hinge plate has different angles with the main ladder hinge plate.

5. The foldable ladder according to claim 4, wherein one of the at least three locking states is taken as an initial locking state, and another locking state exists that satisfies an angle of the auxiliary ladder hinge plate with respect to the main ladder hinge plate=an angle of the auxiliary ladder hinge plate with respect to the main ladder hinge plate in the initial locking state+180 degrees.

6. The foldable ladder according to claim 1, wherein the shaft pin lock assembly comprises a locking pin shaft, a shaft sleeve, a pressure spring, an unlocking handle, a first elastic retaining ring, and a second elastic retaining ring, wherein
the locking pin shaft comprises a shaft body and an end cover connected to a first end of the shaft body, and positioning posts parallel to the shaft body is provided on a side of the end cover facing a second end of the shaft body; a first annular limiting groove extending in a radial circumferential direction of the shaft body is provided at the second end of the shaft body; and a through hole radially passing through the shaft body along the shaft body is provided on the shaft body in a position between the end cover and the first annular limiting groove, and a steel ball spring, a first steel ball, and a second steel ball are provided inside the through hole, and the first steel ball and the second steel ball respectively abut against two ends of the steel ball spring;
the shaft sleeve is sleeved over the shaft body and located on a side of the first annular limiting groove close to the first end of the shaft body, the shaft sleeve comprises a first hollow cylindrical segment and a second hollow cylindrical segment connected to each other, the first hollow cylindrical segment is close to a first end of the locking pin shaft, the second hollow cylindrical segment is close to a second end of the locking pin shaft, and the first hollow cylindrical segment has a diameter greater than that of the second hollow cylindrical segment; a circumferential surface of the second hollow cylindrical segment is provided with a plurality of steel ball limiting holes arranged at intervals along a radial circumferential direction of the second hollow cylindrical segment; and a second annular limiting groove is further provided on an outer circumferential surface of the second hollow cylindrical segment and located on a side of the steel ball limiting holes away from the first hollow cylindrical segment, and the second annular limiting groove extends along the radial circumferential direction of the second hollow cylindrical segment;
the third hinge plate of the main ladder hinge plate is provided with a main ladder middle perforation and main ladder pin shaft holes, the auxiliary ladder hinge plate is provided with an auxiliary ladder middle perforation and a plurality of auxiliary ladder pin shaft holes disposed around the auxiliary ladder middle perforation, the second hollow cylindrical segment of the shaft sleeve passes through the main ladder middle perforation and the auxiliary ladder middle perforation in sequence along a direction extending from the first end to the second end of the shaft body of the locking pin shaft, and the third hinge plate abuts against a step surface formed by a part where the first hollow cylindrical segment and the second hollow cylindrical segment are connected with each other, the positioning posts on the end cover of the locking pin shaft pass through the main ladder pin shaft holes, and the auxiliary ladder hinge plate is connected to the shaft sleeve in a manner of synchronously rotating with the shaft sleeve, and the auxiliary ladder hinge plate is located on a side of the second annular limiting groove close to the first end of the shaft body; and
the first elastic retaining ring is provided in the first annular limiting groove, the second elastic retaining ring is provided in the second annular limiting groove, and the pressure spring is sleeved over the shaft body of the locking pin shaft and is limited between the first elastic retaining ring and the second elastic retaining ring, wherein
in a locking operation condition, the first steel ball and the second steel ball are respectively limited in corresponding steel ball limiting holes on the shaft sleeve under an elastic-force effect of the steel ball spring, and the positioning posts on the end cover of the locking pin shaft pass through the main ladder pin shaft holes and corresponding auxiliary ladder pin shaft holes; and
when the unlocking handle is subjected to an external pressing force, the pressure spring is compressed to push the locking pin shaft to slide as a whole towards a direction of the first end of the shaft body, and the positioning posts on the end cover of the locking pin shaft exit the auxiliary ladder pin shaft holes, and the auxiliary ladder hinge plate can be rotated relatively to the main ladder hinge plate.

7. The foldable ladder according to claim 6, wherein in the locking pin shaft, two positioning posts symmetrically arranged with respect to the shaft body are provided.

8. The foldable ladder according to claim 6, wherein a limiting protrusion is provided on an outer circumferential surface of the second hollow cylindrical segment, the limiting protrusion is located between the steel ball limiting holes and the second annular limiting groove, a raised limiting groove is provided on an inner wall of the auxiliary ladder middle perforation, and the limiting protrusion is snapped in the raised limiting groove.

9. The foldable ladder according to claim 6, wherein in the locking pin shaft, the end cover and the shaft body are fixedly connected together through an opening pin.

10. The foldable ladder according to claim 1, wherein a ladder cap is provided at the top end of the ladder frame of the main ladder; and
an upper surface of the ladder cap is provided with a tool groove, and/or the ladder cap has a width of 140 mm-160 mm.

11. The foldable ladder according to claim 6, wherein the auxiliary ladder pin shaft holes comprise a first hole, a second hole, a third hole, and a fourth hole arranged around the auxiliary ladder middle perforation, wherein the first hole and the fourth hole are symmetrically arranged with respect to the auxiliary ladder middle perforation, and the second hole and the third hole are symmetrical with respect to the auxiliary ladder middle perforation.

12. The foldable ladder according to claim 11, wherein the second operation condition comprises three locking states: a first locking state, a second locking state, and a third locking state, wherein in the first locking state, the auxiliary ladder pin shaft holes through which the two positioning posts pass are the first hole and the fourth hole.

13. The foldable ladder according to claim 11, wherein the second operation condition comprises three locking states: a first locking state, a second locking state, and a third locking state, wherein in the second locking state, the auxiliary ladder pin shaft holes through which the two positioning posts pass are the second hole and the third hole.

14. The foldable ladder according to claim 11, wherein the second operation condition comprises three locking states: a first locking state, a second locking state, and a third locking state, wherein in the third locking state, the auxiliary ladder pin shaft holes through which the two positioning posts pass are the first hole and the fourth hole, and the auxiliary ladder pin shaft holes through which the two positioning posts pass are exchanged in position.

15. The foldable ladder according to claim 6, wherein two opposite surfaces of a circumferential surface of the shaft sleeve has one surface on which three steel ball limiting holes are arranged and the other surface on which another three steel ball limiting holes, symmetrical with the three steel ball limiting holes with respect to the shaft body, are arranged.

16. The foldable ladder according to claim 6, wherein two main ladder pin shaft holes, arranged symmetrically with respect to the main ladder middle perforation, are provided.
